(19) United States
(12) Patent Application Publication
(10) Pub. No.: US 2021/0153707 A1
(43) Pub. Date: May 27, 2021

(54) SELF-PROPELLED VACUUM CLEANER

(71) Applicant: PANASONIC INTELLECTUAL PROPERTY MANAGEMENT CO., LTD., Osaka (JP)

(72) Inventors: Masahiro KAWAI, Shiga (JP); Yoshifumi KORI, Kyoto (JP)

(21) Appl. No.: 17/258,712

(22) PCT Filed: Jun. 21, 2019
(86) PCT No.: PCT/JP2019/024667

§ 371 Date: Jan. 7, 2021

(30) Foreign Application Priority Data
Jul. 20, 2018 (JP) 2018-137079

(51) Int. Cl. A47L 9/28; A47L 9/00

(52) U.S. Cl. CPC A47L 9/2852; A47L 2201/04; A47L 9/009

(57) ABSTRACT

Provided is a self-propelled vacuum cleaner including a main body that is provided with a pair of left and right wheels and that moves on a floor surface to clean the floor surface, a drive unit that is provided on the main body to move or turn the main body, a step detector provided on the main body to detect a step existing around the main body, and a controller that controls the moving unit based on a detection result of the step detector. The controller controls the moving unit to cause the main body to travel on the step in a changed route including a route that is substantially orthogonal to an edge of the step detected by the step detector, when a current traveling direction of the main body tilts with respect to the edge of the step. This provides the self-propelled vacuum cleaner capable of increasing reliability of cleaning for a rug.

### TECHNICAL FIELD

The present invention relates to a self-propelled vacuum cleaner that performs cleaning while running autonomously.

### BACKGROUND ART

There is conventionally known a self-propelled vacuum cleaner that cleans the floor surface while running autonomously (e.g., refer to PTL 1).

The self-propelled vacuum cleaner described in PTL 1 may run on a rug such as a carpet and run on the rug to clean the rug. At this time, when the self-propelled vacuum cleaner enters the rug at an angle to run on the rug, wheels may slip at an edge of the rug to cause the self-propelled vacuum cleaner not to run on the rug. Thus, the self-propelled vacuum cleaner cannot clean the rug.

### CITATION LIST

### Patent Literature

### PTL 1: Japanese Patent No. 4277214

### SUMMARY OF THE INVENTION

The present invention provides a self-propelled vacuum cleaner capable of increasing reliability of cleaning on a rug.

The self-propelled vacuum cleaner of the present invention includes a main body that is provided with a pair of left and right wheels and that moves on a floor surface to clean the floor surface, a moving unit that is provided on the main body and moves or turns the main body, a step detector provided on the main body and detecting a step existing around the main body, and a controller that controls the moving unit based on a detection result of the step detector. The controller controls the moving unit to cause the main body to travel on the step in a changed route including a route that is substantially orthogonal to an edge of the step detected by the step detector, when a current traveling direction of the main body tilts with respect to the edge of the step.

Implementing a program for causing a computer to execute each process of the self-propelled vacuum cleaner also corresponds to implementation of the present invention. As a matter of course, implementing the program using a recording medium on which the program is recorded also corresponds to the implementation of the present invention.

The present invention enables providing a self-propelled vacuum cleaner capable of increasing reliability of cleaning on a rug.

### BRIEF DESCRIPTION OF DRAWINGS

FIG. 1 is a plan view illustrating an appearance of a self-propelled vacuum cleaner according to an exemplary embodiment from above.

FIG. 2 is a bottom view illustrating the appearance of the self-propelled vacuum cleaner from below.

FIG. 3 is a perspective view illustrating the appearance of the self-propelled vacuum cleaner from diagonally above.

FIG. 4 is a schematic sectional view illustrating a schematic structure of a lifter of the self-propelled vacuum cleaner.

FIG. 5 is a block diagram illustrating a control configuration of the self-propelled vacuum cleaner.

FIG. 6 is an explanatory diagram illustrating a case where a traveling direction of a main body of the self-propelled vacuum cleaner does not tilt with respect to an edge of a step.

FIG. 7 is an explanatory diagram illustrating a case where the traveling direction of the main body of the self-propelled vacuum cleaner tilts with respect to the edge of the step.

FIG. 8 is a flowchart illustrating an operation of the self-propelled vacuum cleaner for a step.

FIG. 9 is an explanatory diagram illustrating an uncleaned area when the main body of the self-propelled vacuum cleaner travels on the edge of the step at an angle.

FIG. 10 is an explanatory diagram illustrating a case where the main body of the self-propelled vacuum cleaner deviates from a planned path.

FIG. 11 is an explanatory diagram illustrating an operation of the main body when a charging stand being a destination of the self-propelled vacuum cleaner is on a step.

FIG. 12 is an explanatory diagram illustrating an operation of the main body when the charging stand being the destination of the self-propelled vacuum cleaner is outside the step.

### DESCRIPTION OF EMBODIMENT

Hereinafter, a self-propelled vacuum cleaner according to an exemplary embodiment of the present invention will be described with reference to the drawings. The following exemplary embodiment is merely an example of the self-propelled vacuum cleaner in the present invention. Thus, the present invention is defined by the wording of the scope of claims with reference to the following exemplary embodiment, and is not limited to the following exemplary embodiment. Although components in the following exemplary embodiment includes a component that is not described in the independent claim showing the highest concept of the present invention and that is not necessarily required to achieve an object of the present invention, the component is described to constitute a more preferable form.

The drawings are each a schematic view in which a component is appropriately emphasized, eliminated, and adjusted in ratio to illustrate the present invention, and may be different in shape, positional relationship, and ratio from an actual component.

### EXEMPLARY EMBODIMENT

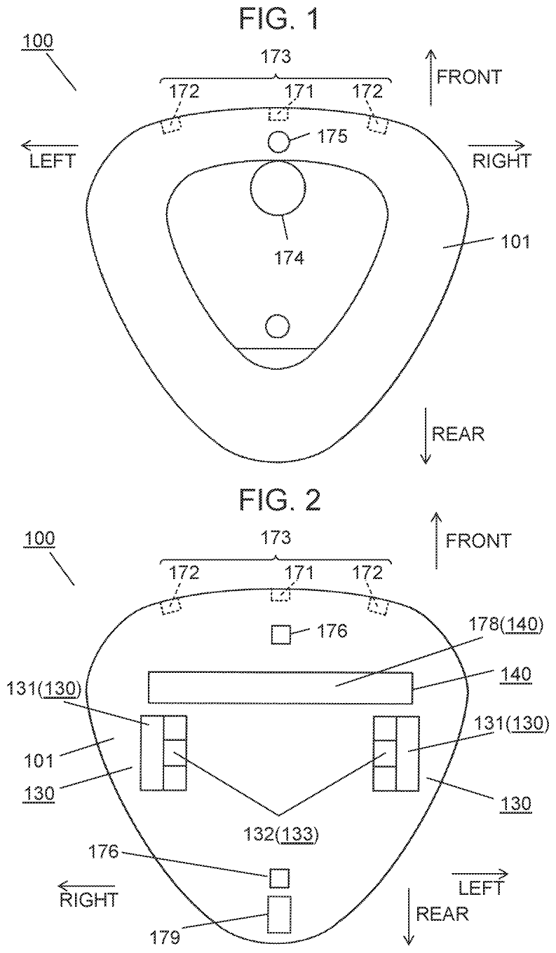

Hereinafter, self-propelled vacuum cleaner 100 according to an exemplary embodiment of the present invention will be described with reference to FIGS. 1 to 3.

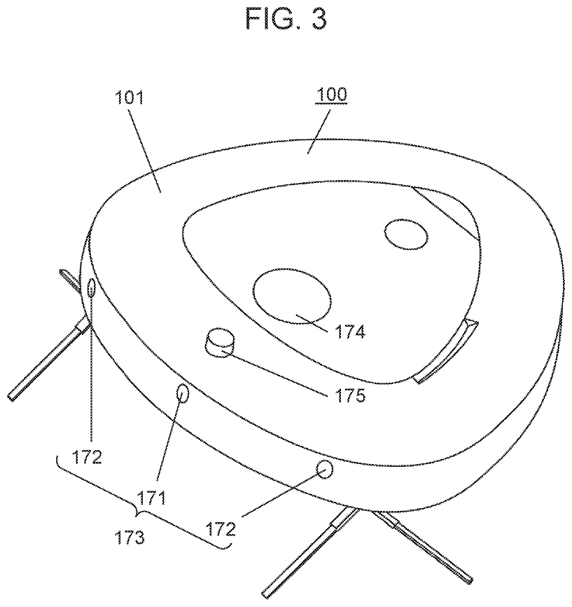

FIG. 1 is a plan view illustrating an appearance of self-propelled vacuum cleaner 100 according to the present exemplary embodiment from above. FIG. 2 is a bottom view illustrating the appearance of self-propelled vacuum cleaner 100 from below. FIG. 3 is a perspective view illustrating the appearance of self-propelled vacuum cleaner 100 from diagonally above.

Self-propelled vacuum cleaner 100 is a cleaning robot that performs cleaning while autonomously moving on a cleaning area such as a floor surface. Specifically self-propelled vacuum cleaner 100 is a robot vacuum cleaner that autonomously runs in a predetermined cleaning area based on an environmental map described later and sucks dust existing in the cleaning area.

As illustrated in FIGS. 1 to 3, self-propelled vacuum cleaner 100 of the present exemplary embodiment includes main body 101, a pair of drive units 130, cleaning unit 140 having suction port 178, and various sensors described later, controller 150, lifter 133, and the like. Main body 101 constitutes an outer shell of self-propelled vacuum cleaner 100 that moves on a cleaning area such as a floor surface and cleans the cleaning area. Cleaning unit 140 sucks dust existing in the cleaning area from suction port 178. A placement relationship is subsequently described, for example, as illustrated in FIG. 1 such that a side on which obstacle sensor 173 described later is disposed is defined as the front, an opposite side is defined as the rear a right side when facing the front is defined as the right, and a left side when facing the front is defined as the left.

As illustrated in FIG. 2, one drive unit 130 is disposed on each left and right side with respect to the center in a width direction in the left-right direction in plan view of self-propelled vacuum cleaner 100. A number of drive units 130 is not limited to two (pair), and may be one, or three or more.

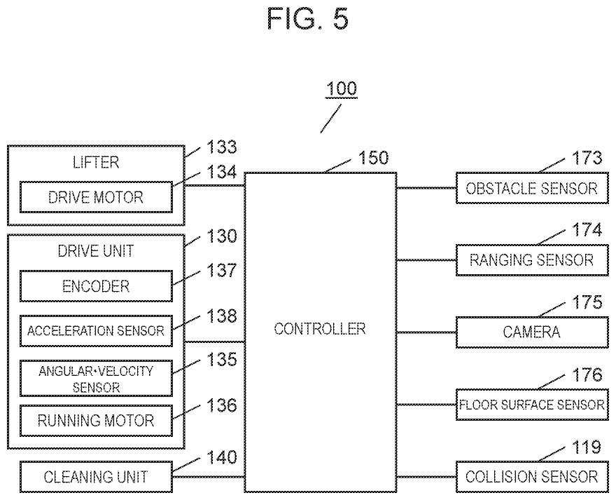

Each of drive units 130 according to the present exemplary embodiment includes wheel 131 that runs on a floor surface, running motor 136 (refer to FIG. 5) that applies torque to wheel 131, a housing that accommodates running motor 136, and the like. Each of wheels 131 is housed in a recess (not illustrated) formed in a lower surface of main body 101, and is rotatably attached to main body 101.

Self-propelled vacuum cleaner 100 further includes caster 179 as an auxiliary wheel to form an opposed two-wheel type. When rotation of each of wheels 131 of the pair of drive units 130 is independently controlled, self-propelled vacuum cleaner 100 can freely run forward, backward, counterclockwise, clockwise, and the like. Specifically, when each of wheels 131 of the pair of drive units 130 is rotated counterclockwise or clockwise while moving forward and backward, self-propelled vacuum cleaner 100 turns right or left when moving forward or backward. In contrast, when each of wheels 131 of the pair of drive units 130 is rotated counterclockwise or clockwise without moving forward or backward, self-propelled vacuum cleaner 100 turns on the current point. That is, drive unit 130 functions as a moving unit for moving or turning main body 101 of self-propelled vacuum cleaner 100. Then, drive units 130 cause self-propelled vacuum cleaner 100 to run in a cleaning area such as a floor surface based on an instruction from controller 150.

Cleaning unit 140 constitutes a unit that collects dust and sucks the dust from suction port 178. Cleaning unit 140 includes a main brush (not illustrated) disposed in suction port 178, a brush drive motor (not illustrated) for rotating the main brush, and the like. Cleaning unit 140 causes a brush drive motor or the like to operate based on an instruction from controller 150.

A suction device (not illustrated) that sucks dust from suction port 178 is disposed inside main body 101. The suction device includes a fan case and an electric fan disposed inside the fan case (not illustrated). The suction device causes the electric fan or the like to operate based on an instruction from controller 150.

Self-propelled vacuum cleaner 100 further includes various sensors exemplified below, such as obstacle sensor 173, ranging sensor 174, collision sensor 119, camera 175, floor surface sensor 176, acceleration sensor 138, and angular velocity sensor 135.

Obstacle sensor 173 detects an obstacle existing in front of main body 101. The present exemplary embodiment uses an ultrasonic sensor as obstacle sensor 173, for example. Obstacle sensor 173 is composed of, for example, one transmitter 171 and two receivers 172. Transmitter 171 is disposed near the center of the front of main body 101, and transmits ultrasonic waves forward. Receivers 172 are disposed on both sides of transmitter 171 and receive the ultrasonic waves transmitted from transmitter 171. That is, obstacle sensor 173 is configured to allow receiver 172 to receive ultrasonic waves that are transmitted from transmitter 171 and returned by being reflected by an obstacle. This allows obstacle sensor 173 to detect a distance between main body 101 and the obstacle, and a position of the obstacle.

Ranging sensor 174 detects a distance between an object, such as an obstacle or a wall, existing around self-propelled vacuum cleaner 100, and self-propelled vacuum cleaner 100. The present exemplary embodiment includes ranging sensor 174 that is composed of, for example, a so-called laser range scanner that scans with a laser beam and measures a distance based on light reflected from an obstacle. Specifically ranging sensor 174 is used to create an environmental map described later.

Collision sensor 119 is composed of, for example, a switch contact displacement sensor, and is provided on a bumper or the like disposed around main body 101 of self-propelled vacuum cleaner 100. The switch contact displacement sensor is turned on when an obstacle comes into contact (or collides) with the bumper and the bumper is pushed against self-propelled vacuum cleaner 100. This allows collision sensor 119 to detect contact with an obstacle.

Camera 175 constitutes a device that images a space in front of main body 101. An image captured by camera 175 is subjected to image processing by, for example, controller 150. This processing allows a shape of an obstacle, for example, in a space in front of main body 101 to be recognized from a position of a feature point in the image.

That is, obstacle sensor 173, ranging sensor 174, and camera 175, which are described above, function as an obstacle detector that detects an obstacle existing around main body 101.

As illustrated in FIG. 2, floor surface sensor 176 is disposed at a plurality of locations on a bottom surface of main body 101 of self-propelled vacuum cleaner 100, and detects whether a cleaning area such as a floor surface exists. The present exemplary embodiment includes floor surface sensor 176 that is composed of, for example, an infrared sensor having a light emitter and a light receiver. That is, when light (infrared ray) radiated from the light emitter returns and is received by the light receiver, floor surface sensor 176 determines the state as “with a floor surface”. In contrast, when the light receiver receives only light below a threshold value, floor surface sensor 176 determines the state as “no floor surface”.

Drive units 130 each further include encoder 137, as illustrated in FIG. 5. Encoder 137 detects a rotation angle of each of the pair of wheels 131 rotated by the corresponding one of running motors 136. Based on information from encoder 137, controller 150 calculates, for example, the amount of running, a turning angle, a speed, acceleration, angular velocity, and the like of self-propelled vacuum cleaner 100.

As illustrated in FIG. 5, drive units 130 each further include acceleration sensor 138, angular velocity sensor 135, and the like. Acceleration sensor 138 detects acceleration when self-propelled vacuum cleaner 100 runs. Angular velocity sensor 135 detects angular velocity when self-propelled vacuum cleaner 100 turns. Information detected by acceleration sensor 138 and angular velocity sensor 135 is used for information to correct an error (e.g., deviation between operation instructions such as movement and turning issued by the controller and actual operation results) caused by, for example, racing of wheels 131.

Obstacle sensor 173, ranging sensor 174, collision sensor 119, camera 175, floor surface sensor 176, the encoder, and the like, which are described above, are examples of sensors. Thus, self-propelled vacuum cleaner 100 of the present exemplary embodiment may be further provided with other different types of sensor, such as a dust sensor, a motion sensor, and a charging-stand-position detection sensor, in addition to the above, if necessary.

Self-propelled vacuum cleaner 100 further includes lifter 133. Lifter 133 constitutes a device for lifting at least a part (e.g., wheel 131) of main body 101.

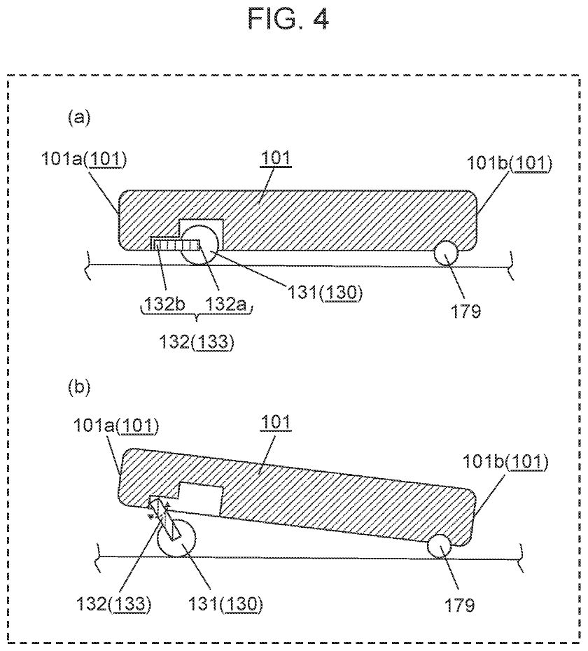

Hereinafter, lifter 133 of self-propelled vacuum cleaner 100 will be described with reference to FIG. 4.

FIG. 4 is a schematic sectional view illustrating a schematic structure of lifter 133 of self-propelled vacuum cleaner 100. Specifically, part (a) of FIG. 4 illustrates a state in which lifting of main body 101 is released by lifter 133 (hereinafter, may be referred to as a “normal state”). Part (b) of FIG. 4 illustrates a state in which main body 101 is lifted by lifter 133 (hereinafter, may be referred to as a “lifted state”).

Lifter 133 is incorporated in drive unit 130 as illustrated in FIGS. 2 and 4. Specifically, lifter 133 includes arm 132, drive motor 134 (refer to FIG. 5), and the like. Arm 132 rotatably holds wheel 131 of drive unit 130 on a side of leading end portion 132a. Drive motor 134 is disposed on a side of base end portion 132b of arm 132, and rotates arm 132 about base end portion 132b. This causes leading end portion 132a of arm 132 to appear and disappear from main body 101 according to a situation.

When leading end portion 132a of arm 132 is housed in main body 101 as illustrated in part (a) of FIG. 4, an installation state of main body 101 is in the normal state. That is, when main body 101 is in the normal state, the various sensors described above each have a detection direction that does not, for example, turn up. This enables various detections required for cleaning to be accurately performed using the various sensors.

In contrast, when leading end portion 132a of arm 132 projects downward from main body 101 (toward the floor surface) as illustrated in part (b) of FIG. 4, main body 101 is in a lifted state. That is, front portion 101a of main body 101 is lifted above rear portion 101b with respect to the floor surface in the lifted state. This causes main body 101 to be in a tilted state in which front portion 101a is higher than rear portion 101b with respect to the floor surface.

That is, lifter 133 lifts front portion 101a of main body 101 according to a situation of surrounding obstacles. Thus, lifter 133 functions to help main body 101 to run on an obstacle during forward movement without colliding with the obstacle. For example, when the obstacle is a rug such as a carpet, main body 101 being not in the lifted state may come into contact with the rug and roll up the rug. When the rug is rolled up, main body 101 comes into contact with a rolled-up portion and is hindered from running further forward. Specifically, the collision sensor or the like reacts due to the contact to cause main body 101 to perform an avoidance operation, so that main body 101 is hindered from running forward. Further, when main body 101 runs into, or slips into the rolled-up rug, cleaning on the rug cannot be performed. When these conditions occur, cleaning performance of self-propelled vacuum cleaner 100 for the rug is deteriorated.

Thus, self-propelled vacuum cleaner 100 of the present exemplary embodiment is configured such that when the obstacle detector detects a rug such as a carpet, lifter 133 is driven to bring main body 101 into the lifted state. This enables main body 101 to easily run on the rug. Thus, interference between main body 101 and the rug is less likely to occur. As a result, self-propelled vacuum cleaner 100 can achieve stable cleaning performance on the rug.

As described above, self-propelled vacuum cleaner 100 of the present exemplary embodiment is configured and operates.

Hereinafter, a control configuration of self-propelled vacuum cleaner 100 having the above configuration will be described with reference to FIG. 5.

FIG. 5 is a block diagram illustrating a control configuration of self-propelled vacuum cleaner 100.

As illustrated in FIG. 5, controller 150 is electrically connected to drive unit 130, obstacle sensor 173, ranging sensor 174, camera 175, floor surface sensor 176, collision sensor 119, cleaning unit 140, lifter 133, and the like. Although FIG. 5 illustrates only one drive unit 130, drive unit 130 is actually provided corresponding to each of left and right wheels 131. That is, self-propelled vacuum cleaner 100 of the present exemplary embodiment has two drive units 130.

Controller 150 includes, for example, a central processing unit (CPU), a random access memory (RAM), a read only memory (ROM), and the like. Controller 150 controls operation of each of the above-mentioned connected units by allowing the CPU to expand a program stored in the ROM into the RAM and execute the program.

Next, control operation of controller 150 will be described.

Controller 150 accumulates data detected by the various sensors described above. Then, controller 150 integrates the accumulated data to create the environmental map described above. Here, the environmental map is a map of an area where self-propelled vacuum cleaner 100 moves within a predetermined cleaning area and performs cleaning. Although a method for creating the environmental map is not particularly limited, examples thereof include simultaneous localization and mapping (SLAM).

Specifically, controller 150 creates the environmental map by forming information based on a running history of self-propelled vacuum cleaner 100, the information indicating an outer shape of a cleaning area where self-propelled vacuum cleaner 100 has actually run and placement of obstacles that hinders running. The environment map is created as, for example, two-dimensional array data. At this time, controller 150 may process the running history as array data by dividing the running history into quadrangles each having a predetermined size such as 10 cm in length and width, and regarding each of the quadrangles as an element area of an array constituting the environment map. The environmental map may be obtained from a device or the like provided outside self-propelled vacuum cleaner 100.

Controller 150 records a running path during cleaning using each coordinate in the environment map during running of self-propelled vacuum cleaner 100. Specifically, controller 150 detects each coordinate in the environmental map of self-propelled vacuum cleaner 100 based on data detected by the various sensors during cleaning, and records each coordinate as the running path.

Controller 150 further controls cleaning unit 140 and the suction device during cleaning. Specifically, controller 150 controls a brush drive motor of cleaning unit 140 and an electric fan of the suction device so that dust on the floor surface is sucked using suction force generated by the electric fan while a main brush of cleaning unit 140 is rotated.

Controller 150 further controls drive motor 134 of lifter 133 based on a detection result whether an obstacle exists acquired by the obstacle detector, and switches a state of main body 101 between the normal state and the lifted state. Specifically, controller 150 determines a route of main body 101 after detection of the obstacle based on the detection result of the obstacle detector when at least one of obstacle sensor 173, ranging sensor 174, and camera 175, which constitute the obstacle detector, detects the obstacle.

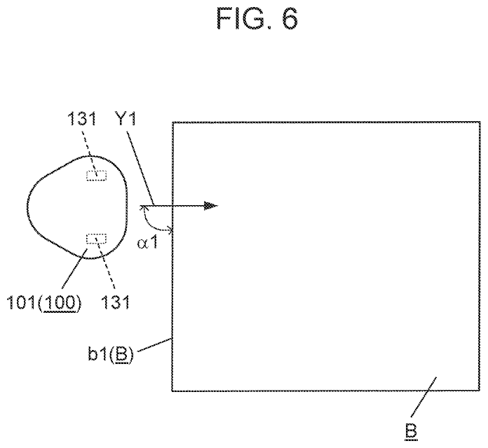

The obstacles described above are classified into an obstacle or step B (refer to FIG. 6 and the like) that self-propelled vacuum cleaner 100 can run over (run on) and an obstacle that self-propelled vacuum cleaner 100 cannot run over. Examples of the obstacle that can be run over include a rug such as a carpet. Examples of the obstacle that self-propelled vacuum cleaner 100 cannot run over include a wall and furniture.

Then, controller 150 determines whether an obstacle can be run over or cannot be run over based on a detection result of collision sensor 119. Hereinafter, an obstacle that can be run over will be referred to as “step B”.

Specifically, controller 150 determines that an obstacle cannot be run over when collision sensor 119 indicates a detection result of ON while the obstacle detector detects the obstacle. In contrast, controller 150 determines that an obstacle is step B that can be run over when collision sensor 119 still indicates a detection result of OFF while the obstacle detector detects the obstacle.

That is, collision sensor 119, and obstacle sensor 173, ranging sensor 174, and camera 175 that constitute the obstacle detector, function as a step detector that detects step B existing around main body 101. When a thickness of the obstacle (height from the floor surface) can be detected from an image of the obstacle captured by camera 175, controller 150 may determine whether the obstacle is step B based on the detected thickness. When at least one of collision sensor 119, obstacle sensor 173, ranging sensor 174, and camera 175 can detect step B existing around main body 101, the at least one of them may constitute the step detector.

As described above, controller 150 controls each unit.

Hereinafter, control operation of controller 150 when step B is detected as an obstacle, for example, will be described.

First, controller 150 recognizes a shape (particularly, a thickness), a size, a position, etc., of step B, based on an image of step B detected by camera 175 constituting the step detector, for example.

Next, controller 150 determines whether the current traveling direction of main body 101 tilts with respect to edge b1 of step B in front of main body 101 based on the recognized result. Controller 150 may determine whether the current traveling direction of main body 101 tilts with respect to edge b1 of step B in front of main body 101 based on a detection result of the step detector other than camera 175.

Next, control by controller 150 and operation of self-propelled vacuum cleaner 100 when step B is detected in front of main body 101 will be described with reference to FIG. 6.

FIG. 6 is an explanatory diagram illustrating a case where traveling direction Y1 of main body 101 of self-propelled vacuum cleaner 100 does not tilt with respect to edge b1 of step B. Here, FIG. 6 illustrates an arrow that indicates current traveling direction Y1 of main body 101.

First, controller 150 detects edge b1 of step B based on an image acquired from camera 175. At this time, although step B includes a plurality of edges b1, controller 150 determines edge b1 facing traveling direction Y1 of main body 101.

Next, controller 150 calculates angle α1 formed by edge b1 to be determined and traveling direction Y1 of main body 101.

At this time, when angle α1 is substantially 90 degrees (including 90 degrees) as illustrated in FIG. 6, controller 150 determines that current traveling direction Y1 is substantially orthogonal (including orthogonal) to edge b1. That is, controller 150 determines that traveling direction Y1 of main body 101 does not tilt with respect to edge b1. In this case, controller 150 causes main body 101 to travel on step B while maintaining current traveling direction Y1.

The term, “substantially” as used herein, means not only complete coincidence but also substantial coincidence, i.e., coincidence including an error of about several percent to several tens of percent.

Next, controller 150 controls drive motor 134 of lifter 133 to lift main body 101 just before main body 101 travels on step B, and then main body 101 is brought into a lifted state as illustrated in part (b) of FIG. 4.

Controller 150 subsequently controls running motor 136 of drive unit 130 to cause main body 101 to run on step B, while maintaining traveling direction Y1 of main body 101. This causes main body 101 to run on step B from edge b1.

After the whole of main body 101 runs on step B, controller 150 controls drive motor 134 of lifter 133 to release the lifted state of main body 101, and then main body 101 is returned to in the normal state as illustrated in part (a) of FIG. 4. This causes main body 101 to be brought into the normal state on step B. Thus, a distance between an upper surface of step B and suction port 178 of cleaning unit 140 becomes constant. As a result, self-propelled vacuum cleaner 100 can exert normal suction force to efficiently suck dust existing on step B, similar to the floor surface.

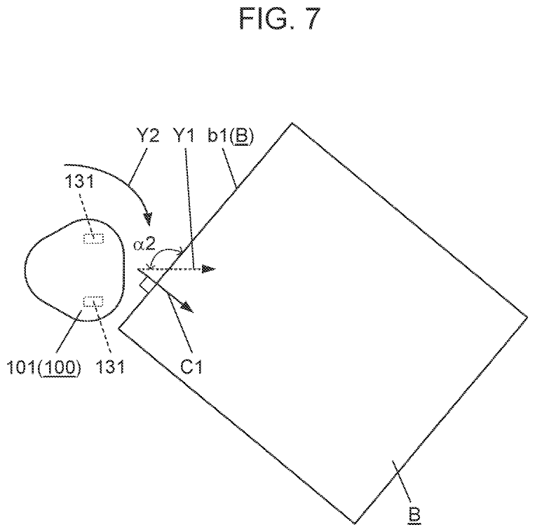

Next, control by controller 150 and operation of self-propelled vacuum cleaner 100 when tilted edge b1 of step B is detected in front of main body 101 will be described with reference to FIG. 7.

FIG. 7 is an explanatory diagram illustrating a case where traveling direction Y1 of main body 101 of self-propelled vacuum cleaner 100 tilts with respect to edge b1 of step B. Here, FIG. 7 illustrates an arrow that indicates current traveling direction Y1 of main body 101.

First, controller 150 detects edge b1 of step B based on an image acquired from camera 175. At this time, controller 150 determines edge b1 existing in traveling direction Y1 of main body 101 among the plurality of edges b1 of step B.

Next, controller 150 calculates angle α2 formed by edge b1 to be determined and traveling direction Y1 of main body 101.

At this time, when angle α2 is not substantially 90 degrees as illustrated in FIG. 7, controller 150 determines that current traveling direction Y1 tilts with respect to edge b1.

Then, controller 150 causes main body 101 to turn clockwise from current traveling direction Y1 by, for example, (180−α2) degrees, for change in direction, and then causes main body 101 to move forward along changed route C1 indicated in FIG. 7. This causes main body 101 to travel on step B in changed route C1. In this case, changed route C1 includes a route that is substantially orthogonal (including orthogonal) to edge b1 of step B. That is, in the present exemplary embodiment, changed route C1 corresponds to a linear route that is substantially orthogonal (including orthogonal) to edge b1 of step B as a whole. Changed route C1 may include a partial route in which main body 101 travels on step B and the whole of main body 101 runs on step B, only the partial route being substantially orthogonal (including orthogonal) to edge b1 of step B.

Specifically, controller 150 controls running motor 136 of drive unit 130 to cause main body 101 to turn clockwise as indicated by arrow Y2 in FIG. 7 to take changed route C1. That is, after turning, main body 101 is in a state facing edge b1 of step B. Then, the facing state allows a route of main body 101 to be changed route C1.

Next, controller 150 controls drive motor 134 of lifter 133 to lift main body 101 just before main body 101 travels on step B, and then main body 101 is brought into a lifted state as illustrated in part (b) of FIG. 4.

Controller 150 subsequently controls running motor 136 of drive unit 130 to cause main body 101 to run on step B in changed route C1. This causes main body 101 to run on step B from edge b1.

After the whole of main body 101 runs on step B, controller 150 controls drive motor 134 of lifter 133 to release the lifted state of main body 101, and then main body 101 is returned to in the normal state as illustrated in part (a) of FIG. 4. This causes main body 101 to be brought into the normal state on step B. Thus, a distance between an upper surface of step B and suction port 178 of cleaning unit 140 becomes constant. As a result, self-propelled vacuum cleaner 100 can exert normal suction force to efficiently suck dust existing on step B, similar to the floor surface.

When a planned path of cleaning (a path through which main body 101 runs) is preliminarily registered in the above exemplary embodiment, controller 150 desirably updates the planned path by reflecting changed route C1 on the planned path. When a planned path is not registered, controller 150 desirably controls drive unit 130 to allow changed route C1 to be included in a subsequent running path of main body 101 based on detection results of the various sensors.

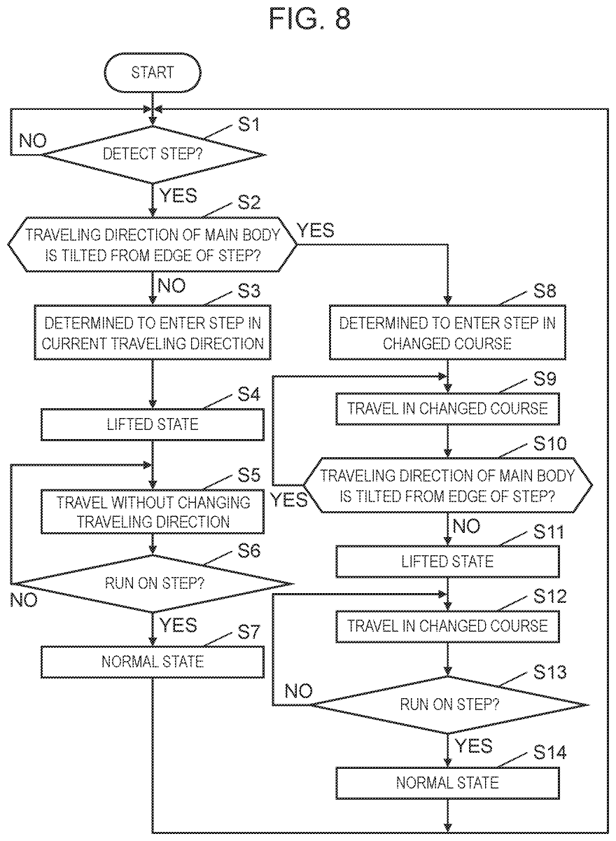

Hereinafter, one mode of operation for step B among operations of self-propelled vacuum cleaner 100 will be described below with reference to FIG. 8.

FIG. 8 is a flowchart illustrating operation of self-propelled vacuum cleaner 100 for step B, according to the exemplary embodiment. The flowchart illustrated in FIG. 8 shows a flow when cleaning is performed.

As illustrated in FIG. 8, when cleaning is started, controller 150 first determines whether the step detector detects step B while main body 101 moves in a predetermined route (step S1). At this time, when step B is not detected (NO in step S1), controller 150 continues cleaning in the same route.

In contrast, when step B is detected (YES in step S1), controller 150 determines whether current traveling direction Y1 of main body 101 tilts with respect to edge b1 of step B existing in front of main body 101 based on a detection result of the step detector (step S2). Here, controller 150 determines step B within a predetermined range in front of main body 101. The predetermined range is set for determining step B approaching main body 101, and is smaller, for example, than a total length of main body 101 in a front-rear direction.

At this time, when current traveling direction Y1 of main body 101 tilts with respect to edge b1 of step B (YES in step S2), controller 150 shifts to step S8 described later.

In contrast, when current traveling direction Y1 of main body 101 does not tilts with respect to edge b1 of step B (NO in step S2), controller 150 determines to travel on step B while maintaining the current traveling direction (step S3).

Then, controller 150 controls drive motor 134 of lifter 133 to lift main body 101 and bring main body 101 into the lifted state (step S4).

Next, controller 150 controls running motor 136 of drive unit 130 to cause main body 101 to run on step B, and causes main body 101 to travel without change in traveling direction (step S5).

Controller 150 subsequently determines whether main body 101 has run on step B based on detection results of the various sensors (step S6). At this time, when main body 101 has not run on step B (NO in step S6), processing proceeds to step S5, and subsequent steps are repeated.

In contrast, when main body 101 has run on step B (YES in step S6), controller 150 controls drive motor 134 of lifter 133 to release lifting of main body 101 and return main body 101 to in the normal state (step S7). This enables main body 101 to exert normal suction force even on step B.

After that, controller 150 proceeds to step S1 and executes subsequent steps.

Here, when current traveling direction Y1 of main body 101 tilts with respect to edge b1 of step B (YES in step S2) in step S2 described above, controller 150 determines to allow main body 101 to travel on step B according to changed route C1 (step S8).

Then, controller 150 controls running motor 136 of drive unit 130 to cause main body 101 to travel according to changed route C1 (step S9).

Next, controller 150 determines whether current traveling direction Y1 of main body 101 tilts with respect to edge b1 of step B existing in front of main body 101 based on a detection result of the step detector (step S10). Here, controller 150 determines step B within a predetermined range in front of main body 101.

At this time, when current traveling direction Y1 of main body 101 tilts with respect to edge b1 of step B (YES in step S10), controller 150 shifts to step S9 and repeats subsequent steps.

In contrast, when current traveling direction Y1 of main body 101 does not tilt with respect to edge b1 of step B (NO in step S10), controller 150 controls drive motor 134 of lifter 133 to lift main body 101 and bring main body 101 into the lifted state (step S11).

Next, after main body 101 is brought into the lifted state, controller 150 controls running motor 136 of drive unit 130 to cause main body 101 to travel in changed route C1 and run on step B (step S12).

Controller 150 subsequently determines whether the whole of main body 101 has run on step B based on detection results of the various sensors (step S13). At this time, when main body 101 has not run on step B (NO in step S13), processing proceeds to step S12, and subsequent steps are repeated.

In contrast, when main body 101 has run on step B (YES in step S13), controller 150 controls drive motor 134 of lifter 133 to release lifting of main body 101 and return main body 101 to in the normal state (step S14). This enables main body 101 to exert normal suction force even on step B.

After that, controller 150 proceeds to step S1 and executes subsequent steps.

As described above, self-propelled vacuum cleaner 100 of the present exemplary embodiment includes main body 101 that has the pair of left and right wheels 131 and that moves on the floor surface to clean the floor surface, and the moving unit (drive unit 130) that is provided in main body 101 and moves or turns main body 101. Self-propelled vacuum cleaner 100 further includes the step detector (collision sensor 119, obstacle sensor 173, ranging sensor 174, and camera 175) that is provided in main body 101 and detecting step B existing around main body 101, and controller 150 that controls the moving unit based on a detection result of the step detector. When it is detected that current traveling direction Y1 of main body 101 tilts with respect to edge b1 of step B detected by the step detector, controller 150 controls the moving unit to cause main body 101 to travel on step B in changed route C1 including a route that is substantially orthogonal to edge b1 of step B.

This causes main body 101 to travel on step B in changed route C1 including a route that is substantially orthogonal (including orthogonal) to edge b1 of step B, when current traveling direction Y1 of main body 101 tilts with respect to edge b1 of step B. Then, main body 101 runs on step B in the route that is substantially orthogonal (including orthogonal) to edge b1 of step B, so that main body 101 can be prevented from entering step B at an angle. Thus, main body 101 causes wheel 131 to be less likely to slip at edge b1 of step B. This enables main body 101 to reliably run on step B. As a result, cleaning with main body 101 for step B (rug) can be increased in certainty.

When main body 101 travels on step B at an angle, only one of the pair of wheels 131 may run on step B and another wheel 131 may race. Occurrence of racing may cause change in traveling direction of main body 101 and failure in detection of a current position, so that running control of main body 101 may be unstable. In contrast, self-propelled vacuum cleaner 100 of the present exemplary embodiment changes a direction of main body 101 to a route (changed route C) that is substantially orthogonal (including orthogonal) to edge b1 of step B. Thus, the pair of wheels 131 also runs on step B at almost the same time. This enables increase in certainty of the traveling control of main body 101 by avoiding a state in which only one wheel 131 runs on step B.

Self-propelled vacuum cleaner 100 of the present exemplary embodiment further includes lifter 133 that is provided on main body 101 and lifting main body 101 from the floor surface. Lifter 133 can bring main body 101 into the lifted state or the normal state according to a situation. Then, the lifted state allows main body 101 to easily run on step B. This causes interference with step B, such as contact between main body 101 and step B or slipping of main body 101 into step B, to be less likely to occur. As a result, stable cleaning performance can be achieved for step B.

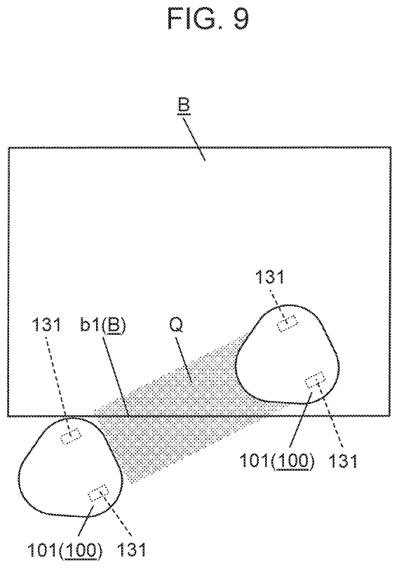

Main body 101 in the lifted state increases a distance from suction port 178 to the floor surface or step B to more than that in the normal state, so that suction force deteriorates. Thus, the lifted state causes generation of an area where normal cleaning is not performed (uncleaned area Q) as illustrated in FIG. 9.

FIG. 9 is an explanatory diagram illustrating uncleaned area Q generated when main body 101 of self-propelled vacuum cleaner 100 enters edge b1 of step B at an angle.

As illustrated in FIG. 9, when main body 101 travels on edge b1 of step B at an angle, main body 101 is in the lifted state until completely passing through edge b1. Thus, a wide range of uncleaned area Q is formed in a cleaning area. Then, self-propelled vacuum cleaner 100 of the present exemplary embodiment causes main body 101 to travel on step B in changed route C1 including a route that is substantially orthogonal (including orthogonal) to edge b1 of step B as described above. This enables main body 101 to pass through edge b1 of step B in a short time. That is, uncleaned area Q can be reduced by shortening time in the lifted state of main body 101.

The present invention is not limited to the above exemplary embodiment. For example, exemplary embodiments of the present invention may include another exemplary embodiment configured by appropriately combining components described in the present specification or excluding some of the components. The present invention also includes modifications obtained by making various modifications that can be conceived by those skilled in the art without departing from the scope of the gist of the present invention, i.e., the meaning indicated by the words described in the scope of claims.

For example, controller 150 may create a planned path of cleaning by itself based on the environmental map, or may be configured to receive a planned path from an external device. Each case is included in acquisition of a planned path by controller 150.

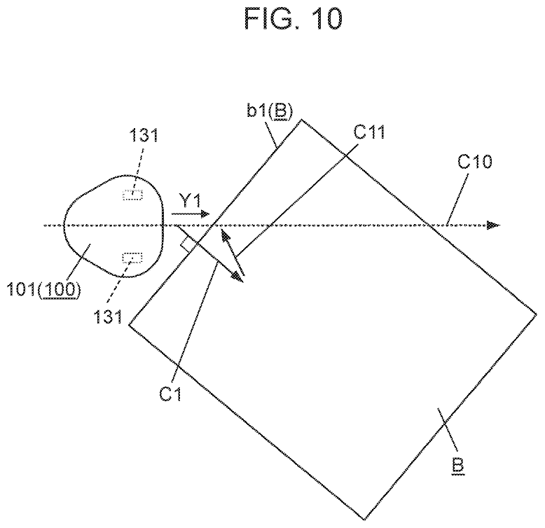

In this case, even when controller 150 acquires planned path C10 of cleaning, selecting changed route C1 may cause main body 101 to deviate from planned path C10 as illustrated in FIG. 10.

FIG. 10 is an explanatory diagram illustrating a control operation when main body 101 deviates from planned path C10. FIG. 10 is illustrated assuming that controller 150 preliminarily acquires planned path C10 that linearly passes through step B, for example.

First, traveling direction Y1 of main body 101 is to be along planned path C10 as illustrated in FIG. 10. At this time, when the step detector detects step B in the middle of traveling, controller 150 determines whether current traveling direction Y1 of main body 101 tilts with respect to edge b1 of step B detected. When the step detector detects that traveling direction Y1 is tilted, controller 150 controls drive unit 130 to change the traveling direction to that in changed route C1 including a route that is substantially orthogonal (including orthogonal) to edge b1 of step B and cause main body 101 to travel on step B. Thus, main body 101 deviates from planned path C10.

Next, controller 150 causes main body 101 to travel on step B in changed route C1, and causes the whole of main body 101 to travel to a predetermined position on step B that allows change in direction.

Controller 150 subsequently controls drive unit 130 to cause main body 101 having entered step B in changed route C1 to return to planned path C10 from changed route C1 along return path C11 on step B.

Specifically, controller 150 controls drive unit 130 to cause main body 101 to return to a midway position in planned path C10 on step B from a predetermined position in changed route C1 according to return path C11. As illustrated in FIG. 10, the midway position is a position where main body 101 does not fall from step B and is as close as possible to edge b1 of step B. This enables reducing an intermittent portion of planned path C10, in which main body 101 travels outside planned path C10 in which main body 101 originally travels. As a result, an uncleaned area occurring in planned path C10 can be minimized.

That is, although controller 150 controls main body 101 to travel along planned path C10 of cleaning that is preliminarily acquired, main body 101 may deviate from planned path C10 depending on a positional relationship between planned path C10 and edge b1 of step B. Thus, when main body 101 traveling on step B deviates from planned path C10, controller 150 controls the moving unit (drive unit 130) to cause main body 101 to return to planned path C10 along return path C11 on step B.

This enables main body 101 to be surely returned to planned path C10 on step B even when changed route C1 is selected. As a result, after returning, main body 101 moves on step B according to planned path C10 to enable reliable cleaning.

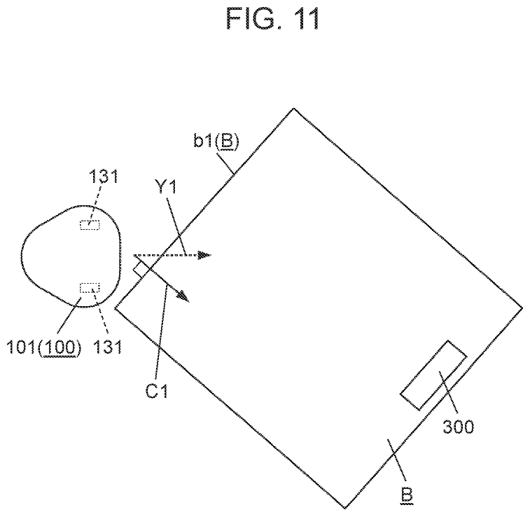

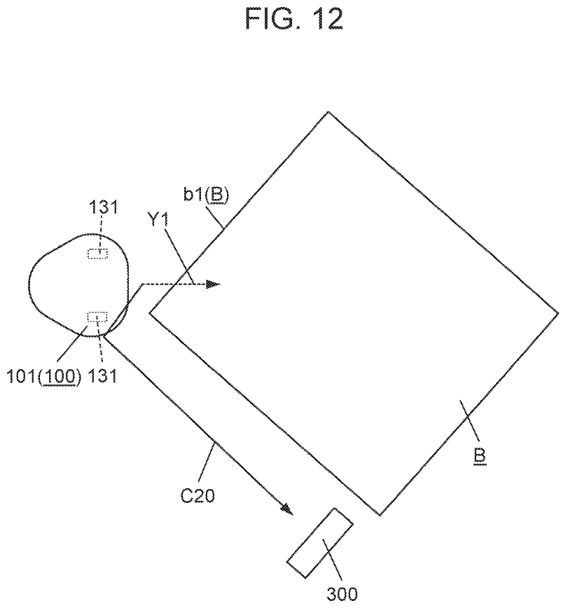

Self-propelled vacuum cleaner 100 of the present exemplary embodiment may automatically return main body 101 to charging stand 300 being a destination (refer to FIGS. 11 and 12) in a final phase of cleaning, for example.

At this time, when charging stand 300 is installed on step B as illustrated in FIG. 11, main body 101 is required to be run on step B at the time of returning to charging stand 300.

In contrast, when charging stand 300 is installed outside step B as illustrated in FIG. 12, main body 101 is not necessarily to be run on step B and moved at the time of returning to charging stand 300. Thus, controller 150 determines whether charging stand 300 is installed on step B, and controls drive unit 130 to head toward charging stand 300 in a different route. Examples of timing at which main body 101 returns to charging stand 300 include timing when cleaning in a predetermined area is almost completed, timing when charging is required, and the like.

First, operation of main body 101, for example, when charging stand 300 is installed on step B will be specifically described with reference to FIG. 11.

FIG. 11 is an explanatory diagram illustrating an operation of main body 101 when charging stand 300 being a destination of self-propelled vacuum cleaner 100 is on step B.

Controller 150 will be described for a case where coordinates of charging stand 300 are acquired based on an environmental map in which the coordinates of charging stand 300 are preliminarily registered, for example.

In this case, controller 150 determines whether charging stand 300 is on step B detected by the step detector at the time of returning main body 101. Specifically controller 150 first recognizes a shape (particularly a thickness), a size, a position, etc., of step B, based on an image of step B captured by camera 175. Then, controller 150 compares the recognized result with the coordinates of charging stand 300 acquired preliminarily to determine whether charging stand 300 is on step B.

Next, when controller 150 determines that charging stand 300 is on step B as illustrated in FIG. 11, controller 150 further determines whether current traveling direction Y1 of main body 101 tilts with respect to edge b1 of step B.

Then, when determining that current traveling direction Y1 of main body 101 tilts with respect to edge b1 of step B, controller 150 controls drive unit 130 to cause main body 101 to travel on step B in changed route C1.

In contrast, when determining that charging stand 300 exists on step B and current traveling direction Y1 of main body 101 does not tilt with respect to edge b1 of step B, controller 150 controls drive unit 130 to cause main body 101 to travel on step B still in current traveling direction Y1.

After that, when main body 101 runs on step B in changed route C1 or still in current traveling direction Y1, controller 150 controls drive unit 130 to cause main body 101 to move and return to charging stand 300 on step B.

When charging stand 300 is installed on step B, main body 101 operates as described above.

Hereinafter, operation of main body 101, for example, when charging stand 300 is installed outside step B will be specifically described with reference to FIG. 12.

FIG. 12 is an explanatory diagram illustrating an operation of main body 101 when charging stand 300 being a destination of self-propelled vacuum cleaner 100 is outside step B.

First, controller 150 determines whether charging stand 300 is on step B detected by the step detector such as camera 175 as described above, at the time of returning main body 101.

Then, when determining that charging stand 300 is outside step B as illustrated in FIG. 12, controller 150 changes the route of main body 101 from current traveling direction Y1 to avoidance route C20. Avoidance route C20 is set to reach charging stand 300 by avoiding step B.

Next, controller 150 controls drive unit 130 to cause main body 101 to move and return to charging stand 300 in avoidance route C20. As a result, main body 101 can be reduced in frequency of running over step B, when returning to charging stand 300.

That is, controller 150 first acquires a position of charging stand 300 in a final phase of cleaning, based on the environmental map. Then, when charging stand 300 is on step B detected by the step detector, controller 150 controls drive unit 130 to cause main body 101 to travel on step B. In contrast, when charging stand 300 is outside step B detected by the step detector, controller 150 controls drive unit 130 to avoid step B and reach charging stand 300.

As a result, when charging stand 300 is outside step B, main body 101 reaches charging stand 300 by avoiding step B. Thus, main body 101 can be reduced in frequency of running overstep B, when returning to charging stand 300. This enables reducing a possibility that main body 101 strands on step B and cannot move, for example.

Although the above exemplary embodiment describes charging stand 300 as a destination, for example, a point other than charging stand 300 may be set as a destination. For example, a point registered in controller 150, a final point of the planned path, or the like may be set as a destination.

Although the above exemplary embodiment describes controller 150 for a case where controller 150 determines whether current traveling direction Y1 of main body 101 tilts with respect to edge b1 of step B in front of main body 101 based on an image captured by camera 175, for example, the present invention is not limited to this. For example, a ranging sensor may be mounted on each of a right front portion and a left front portion of main body 101, and the ranging sensor may acquire a tilt of traveling direction Y1 of main body 101 with respect to edge b1 of step B. Specifically, controller 150 acquires an interval (distance) from the right front portion of main body 101 to step B and an interval (distance) from the left front portion of main body 101 to step B based on a detection result of the corresponding one of the ranging sensors, and detects the tilt of traveling direction Y1 of main body 101 with respect to edge b1 from these intervals (distances). That is, for example, when any one of the acquired intervals (distances) is larger than a predetermined value, it is determined that current traveling direction Y1 of main body 101 tilts with respect to edge b1 of step B. Then, controller 150 controls drive unit 130 to cause main body 101 to travel on step B in changed route C1.

When current traveling direction Y1 of main body 101 tilts with respect to edge b1 of step B detected by the step detector, controller 150 may be configured to select a different route in accordance with an angle formed by edge b1 and traveling direction Y1 to cause main body 101 to move.

Specifically, when the angle formed by edge b1 and traveling direction Y1 on an obtuse angle side is less than a predetermined value, controller 150 controls the moving unit to cause main body 101 to travel on step B in changed route C1.

In contrast, when the angle formed by edge b1 and traveling direction Y1 on the obtuse angle side is equal to or more than the predetermined value, controller 150 controls the moving unit to avoid step B. This enables an appropriate route to be selected in accordance with an angle formed by edge b1 and traveling direction Y1, and thus enables efficient cleaning. Here, the predetermined value is a threshold value for determining whether to select changed route C1 or avoidance, and is specifically a value of 90 degrees or more. The predetermined value is determined based on various simulations, experiments, empirical rules, and the like.

### INDUSTRIAL APPLICABILITY

The present invention is applicable to a self-propelled vacuum cleaner that is capable of autonomous running, and that requires a reliable cleaning operation for a step such as a rug.

### REFERENCE MARKS IN THE DRAWINGS

100: self-propelled vacuum cleaner
101: main body
101a: front portion
101b: rear portion
119: collision sensor (step detector)
130: drive unit (moving unit)
131: wheel
132: arm
132a: leading end portion
132b: base end portion
133: lifter
134: drive motor
135: angular velocity sensor
136: running motor
137: encoder
138: acceleration sensor
140: cleaning unit
150: controller
171: transmitter
172: receiver
173: obstacle sensor (step detector)
174: ranging sensor (step detector)
175: camera (step detector)
176: floor surface sensor
178: suction port
179: caster
300: charging stand
B: step
b1: edge
C1: changed route
C10: planned path
C11: return path
C20: avoidance route
Q: uncleaned area
Y1: traveling direction
Y2: arrow
α1, α2: angle

1. A self-propelled vacuum cleaner comprising:
a main body that is provided with a pair of left and right wheels and that moves on a floor surface to clean the floor surface;
a moving unit that is provided on the main body and moves or turns the main body;
a step detector provided on the main body and detects a step existing around the main body; and
a controller that controls the moving unit based on a detection result of the step detector,
the controller controlling the moving unit to cause the main body to travel on the step in a changed route including a route that is substantially orthogonal to an edge of the step detected by the step detector, when a current traveling direction of the main body tilts with respect to the edge of the step.

2. The self-propelled vacuum cleaner according to claim 1, further comprising a lifter provided on the main body and lifting the main body from the floor surface.

3. The self-propelled vacuum cleaner according to claim 1, wherein the controller acquires a planned path of cleaning, and controls the moving unit to cause the main body to return to the planned path on the step, when the step causes the main body to deviate from the planned path.

4. The self-propelled vacuum cleaner according to claim 1, wherein
the controller obtains a final destination of cleaning,
when the final destination is on the step detected by the step detector, the controller controls the moving unit to cause the main body to travel on the step, and
when the final destination is outside the step detected by the step detector, the controller controls the moving unit to reach the final destination by avoiding the step.

5. The self-propelled vacuum cleaner according to claim 1, wherein
when the current traveling direction of the main body tilts with respect to the edge of the step detected by the step detector, the controller controls the moving unit to cause the main body to travel on the step in the changed route when an angle formed by the edge and the current traveling direction on an obtuse angle side is less than a predetermined value, and
when the angle formed by the edge and the current traveling direction on the obtuse angle side is equal to or more than the predetermined value, the controller controls the moving unit to avoid the step.

6. The self-propelled vacuum cleaner according to claim 2, wherein the controller acquires a planned path of cleaning, and controls the moving unit to cause the main body to return to the planned path on the step, when the step causes the main body to deviate from the planned path.

7. The self-propelled vacuum cleaner according to claim 2, wherein
the controller obtains a final destination of cleaning,
when the final destination is on the step detected by the step detector, the controller controls the moving unit to cause the main body to travel on the step, and
when the final destination is outside the step detected by the step detector, the controller controls the moving unit to reach the final destination by avoiding the step.

8. The self-propelled vacuum cleaner according to claim 3, wherein
the controller obtains a final destination of cleaning,
when the final destination is on the step detected by the step detector, the controller controls the moving unit to cause the main body to travel on the step, and
when the final destination is outside the step detected by the step detector, the controller controls the moving unit to reach the final destination by avoiding the step.

9. The self-propelled vacuum cleaner according to claim 6, wherein
the controller obtains a final destination of cleaning,
when the final destination is on the step detected by the step detector, the controller controls the moving unit to cause the main body to travel on the step, and
when the final destination is outside the step detected by the step detector, the controller controls the moving unit to reach the final destination by avoiding the step.

10. The self-propelled vacuum cleaner according to claim 2, wherein
when the current traveling direction of the main body tilts with respect to the edge of the step detected by the step detector, the controller controls the moving unit to cause the main body to travel on the step in the changed route when an angle formed by the edge and the current traveling direction on an obtuse angle side is less than a predetermined value, and
when the angle formed by the edge and the current traveling direction on the obtuse angle side is equal to or more than the predetermined value, the controller controls the moving unit to avoid the step.

11. The self-propelled vacuum cleaner according to claim 3, wherein
when the current traveling direction of the main body tilts with respect to the edge of the step detected by the step detector, the controller controls the moving unit to cause the main body to travel on the step in the changed route when an angle formed by the edge and the current traveling direction on an obtuse angle side is less than a predetermined value, and
when the angle formed by the edge and the current traveling direction on the obtuse angle side is equal to or more than the predetermined value, the controller controls the moving unit to avoid the step.

12. The self-propelled vacuum cleaner according to claim 6, wherein
when the current traveling direction of the main body tilts with respect to the edge of the step detected by the step detector, the controller controls the moving unit to cause the main body to travel on the step in the changed route when an angle formed by the edge and the current traveling direction on an obtuse angle side is less than a predetermined value, and
when the angle formed by the edge and the current traveling direction on the obtuse angle side is equal to or more than the predetermined value, the controller controls the moving unit to avoid the step.

13. The self-propelled vacuum cleaner according to claim 4, wherein
when the current traveling direction of the main body tilts with respect to the edge of the step detected by the step detector, the controller controls the moving unit to cause the main body to travel on the step in the changed route when an angle formed by the edge and the current traveling direction on an obtuse angle side is less than a predetermined value, and
when the angle formed by the edge and the current traveling direction on the obtuse angle side is equal to or more than the predetermined value, the controller controls the moving unit to avoid the step.

14. The self-propelled vacuum cleaner according to claim 7, wherein
when the current traveling direction of the main body tilts with respect to the edge of the step detected by the step detector, the controller controls the moving unit to cause the main body to travel on the step in the changed route when an angle formed by the edge and the current traveling direction on an obtuse angle side is less than a predetermined value, and
when the angle formed by the edge and the current traveling direction on the obtuse angle side is equal to or more than the predetermined value, the controller controls the moving unit to avoid the step.

15. The self-propelled vacuum cleaner according to claim 8, wherein
when the current traveling direction of the main body tilts with respect to the edge of the step detected by the step detector, the controller controls the moving unit to cause the main body to travel on the step in the changed route when an angle formed by the edge and the current traveling direction on an obtuse angle side is less than a predetermined value, and
when the angle formed by the edge and the current traveling direction on the obtuse angle side is equal to or more than the predetermined value, the controller controls the moving unit to avoid the step.

16. The self-propelled vacuum cleaner according to claim 9, wherein
when the current traveling direction of the main body tilts with respect to the edge of the step detected by the step detector, the controller controls the moving unit to cause the main body to travel on the step in the changed route when an angle formed by the edge and the current traveling direction on an obtuse angle side is less than a predetermined value, and
when the angle formed by the edge and the current traveling direction on the obtuse angle side is equal to or more than the predetermined value, the controller controls the moving unit to avoid the step.
